(19) United States
(12) Patent Application Publication
(10) Pub. No.: US 2013/0223773 A1
(43) Pub. Date: Aug. 29, 2013

(54) BEARING DEVICE

(71) Applicants: MING-HSIU CHUNG, Tu-Cheng (TW); NIEN-TIEN CHENG, Tu-Cheng (TW)

(72) Inventors: MING-HSIU CHUNG, Tu-Cheng (TW); NIEN-TIEN CHENG, Tu-Cheng (TW)

(73) Assignee: FOXCONN TECHNOLOGY CO., LTD., Tu-Cheng (TW)

(21) Appl. No.: 13/563,747

(22) Filed: Aug. 1, 2012

(30) Foreign Application Priority Data
Feb. 23, 2012 (TW) 101106037

(51) Int. Cl. F16C 33/10; F16C 17/00

(52) U.S. Cl. 384/279; 384/322

(57) ABSTRACT

A bearing device includes a cylindrical body. The body defines an axial hole for rotatably receiving a rotatable member therein. The body defines a guiding groove at a side wall thereof. The guiding groove has a bottom end communicating a bottom of the axial hole and a top end at the body. The body defines a bore in a middle portion thereof to communicate the axial hole and the top end of the guiding groove, whereby lubricant can flow in a loop in the body.

### BACKGROUND

1. Technical Field

The disclosure relates to bearing devices, and particularly to a bearing device having good lubricant retention.

2. Description of the Related Art

At present, bearings are widely used in spindle motors in devices, such as compact disc (CD) drivers, digital video disc (DVD) drivers, hard disk drivers, laser beam printers, floppy disk drivers or in heat-dissipation fans. Spindle motors require bearings with small size, high rotational accuracy and long life. A related bearing defines a bearing hole therein. A shaft is rotatably received in the bearing hole.

Lubricant is often used between an inner circumferential surface of the bearing and an external circumferential surface of the shaft to reduce abrasion of the bearing and the shaft. However, the lubricant is prone to leak out of the related bearing so that the bearing cannot work normally due to lack of lubricant. Thus, lubricant retention becomes a problem in the related bearing.

Therefore, it is desirable to provide a bearing device having good lubricant retention and a long operating life.

### BRIEF DESCRIPTION OF THE DRAWINGS

The components of the drawings are not necessarily drawn to scale, the emphasis instead being placed upon clearly illustrating the principles of the embodiments of the display device. Moreover, in the drawings, like reference numerals designate corresponding parts throughout several views.

FIG. 1 is an isometric, assembled view of a bearing device, according to a first embodiment.

FIG. 2 is an exploded view of the bearing device of FIG. 1.

FIG. 3 is an inverted view of the bearing device of FIG. 2.

FIG. 4 is a longitudinally cutaway view of the bearing device of FIG. 1 used in a bearing sleeve.

FIG. 5 is a longitudinally cutaway view similar to FIG. 4, but shown from another aspect.

FIG. 6 is an isometric, longitudinally cutaway view of a bearing device, according to a second embodiment.

### DETAILED DESCRIPTION

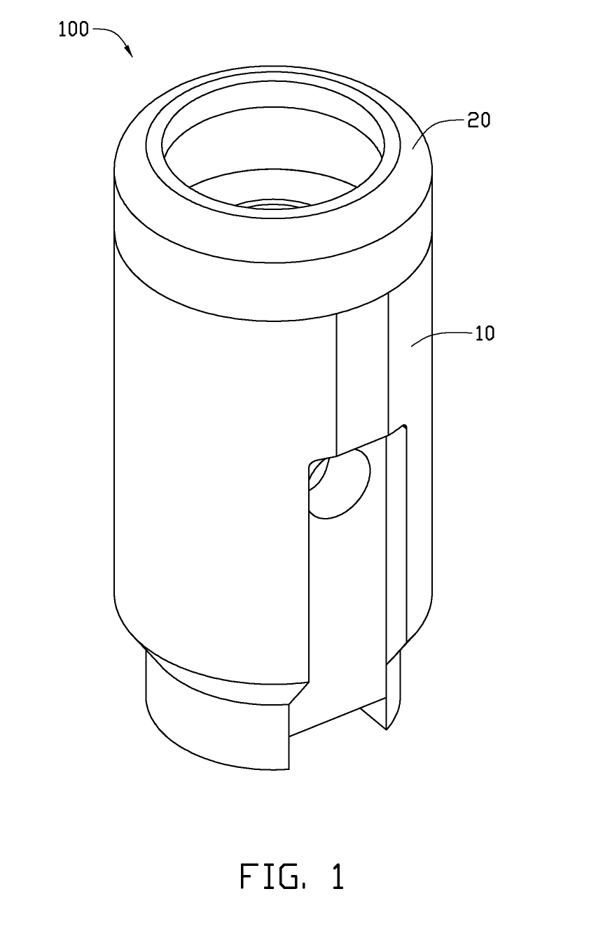

Referring to FIG. 1, a bearing device 100 in accordance with a first embodiment of the disclosure is shown. The bearing device 100 includes a cylindrical body 10 and a cover 20 mounted on the body 10.

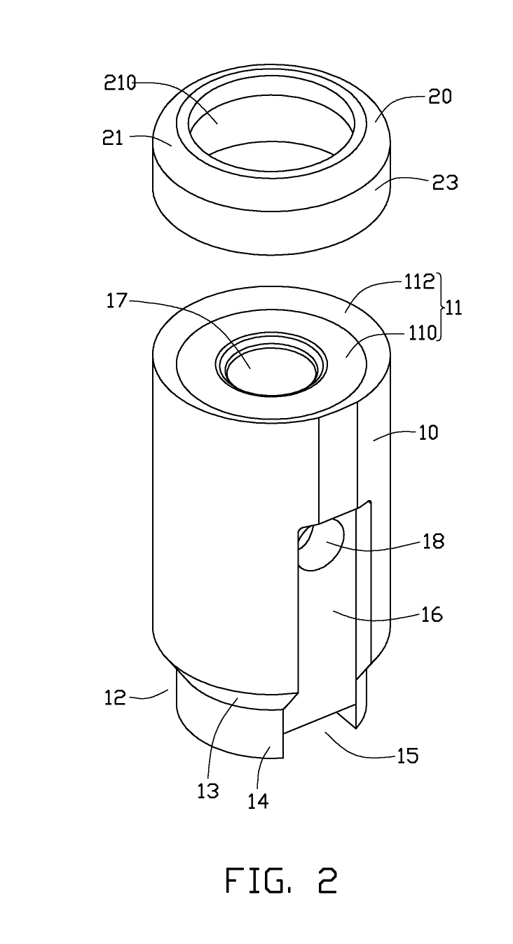

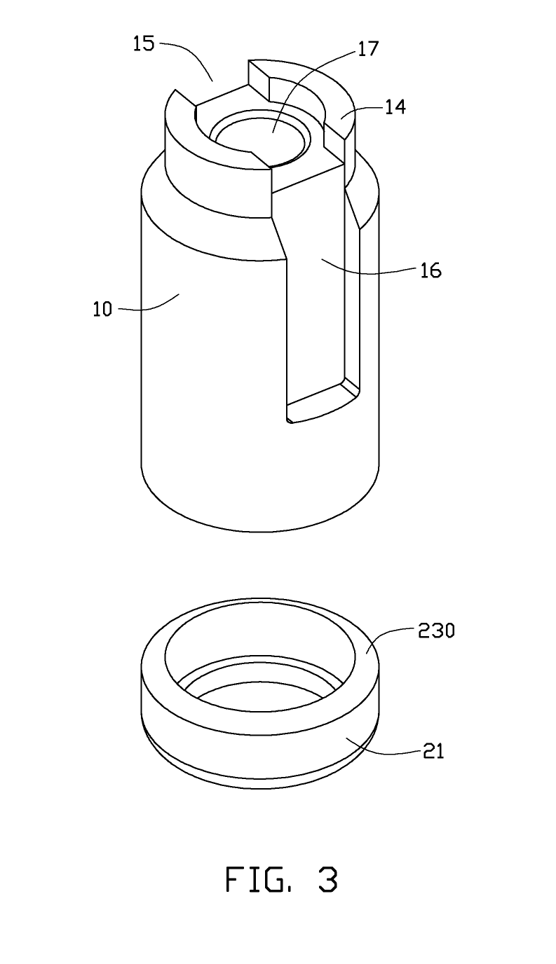

Referring to FIGS. 2 and 3, the body 10 is made of metal power and formed by an injection molding process. The body 10 defines an axial hole 17 extending through a top to a bottom thereof. The body 10 defines a recess 11 at a top thereof. The body 10 has a planar surface 110 and inclined surface 112 around the planar surface 110 in the recess 11. The planar surface 110 is annular. A bottom of the body 10 defines an annular undercut 12 to have a guiding surface 13.

A diameter of the guiding surface 13 gradually decreases from top to bottom. A center of the bottom of the body 10 defines a through groove 15 to divide the bottom of the body 10 into two walls 14. The through groove 15 is communicated with the axial hole 17 of the body 10. The body 10 defines two vertical guiding grooves 16 at two side walls thereof. Each of the guiding grooves 16 has a bottom end communicating the through groove 15 and a top end adjacent to a middle portion of the body 10. The body 10 defines a bore 18 communicating the axial hole 17 and the top end of one of the guiding grooves 16. Alternatively, the body 10 can define two bores 18 each communicating the axial hole 17 and the top end of each guiding grooves 16.

The cover 20 includes a top circular wall 21, and an annular wall 23 extending perpendicularly downward from a periphery of the top circular wall 21. The circular wall 21 defines a central hole 210. The circular wall 21 has an engaging surface 230 at a bottom thereof. The engaging surface 230 gradually decreases from outer edge to inner edge thereof. When the cover 20 is mounted on the body 10, the engaging surface 230 is correspondingly engaged on the inclined surface 112 of the body 10.

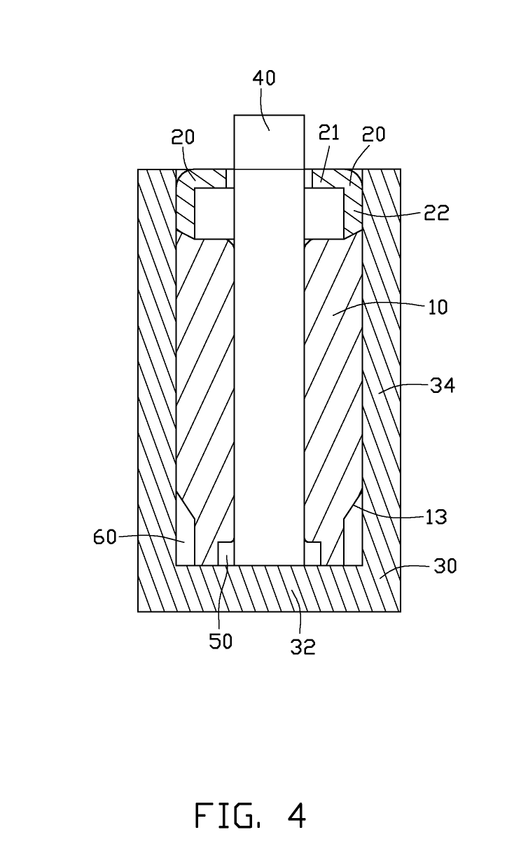

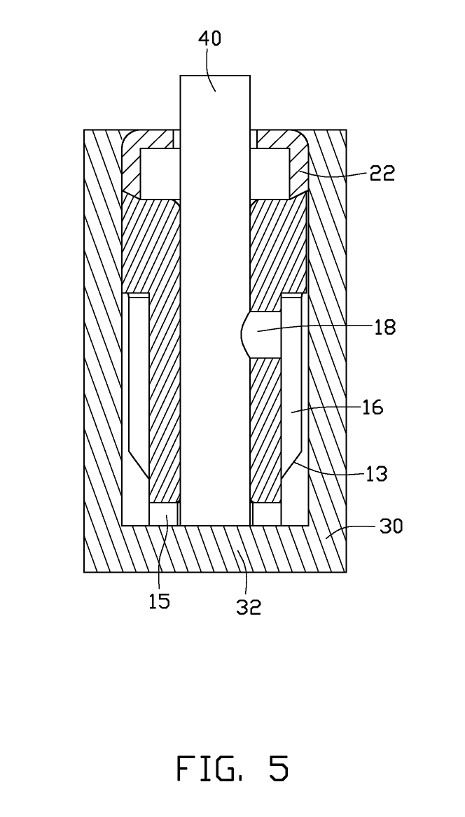

Referring to FIGS. 4 and 5, in use, the bearing device 100 is received in a bushing 30 and to receive a shaft 40 extending through the axial hole 17 of the body 10 and the central hole 210 of the circular wall 21. The bearing device 100, the bushing 30 and the shaft 40 combine to a bearing assembly. The bushing 30 includes a bottom plate 32 and a sleeve 34 extending from a periphery of the bottom plate 32. The walls 14 of the body 10 abut on the bottom plate 32. Inner surfaces of the walls 14 and the bottom plate 32 together define a first storing room 50. Outer surface of the walls 14, inner surface of the sleeve 34 and the bottom plate 32 together define a second storing room 60. Lubricant is filled in the first storing room 50, the second storing room 60 and gaps between the body 10 and the shaft 40. The cover 20 is mounted on the body 10 and received in the sleeve 34.

During rotation of the shaft 40, the lubricant is driven flowing from the first storing room 50 to the gap between the body 10 and the shaft 40. Accordingly, a fluid dynamic pressure is generated in the gap between the body 10 and the shaft 40 to prevent the shaft 40 directly contacting the body 10. Part of the lubricant flows out along the bore 18 and the corresponding guiding groove 16 to the second storing room 60, and returns to the first storing room 50 via the through groove 15. A circumfluence of the lubricant flowing through the first storing room 50, the gap between the body 10 and the shaft 40, the bore 18, the guiding groove 16, the second storing room 60 and the through groove 15 in sequence, prevents the lubricant from flowing to a top of the body 10 and leaking out of the bearing device 100.

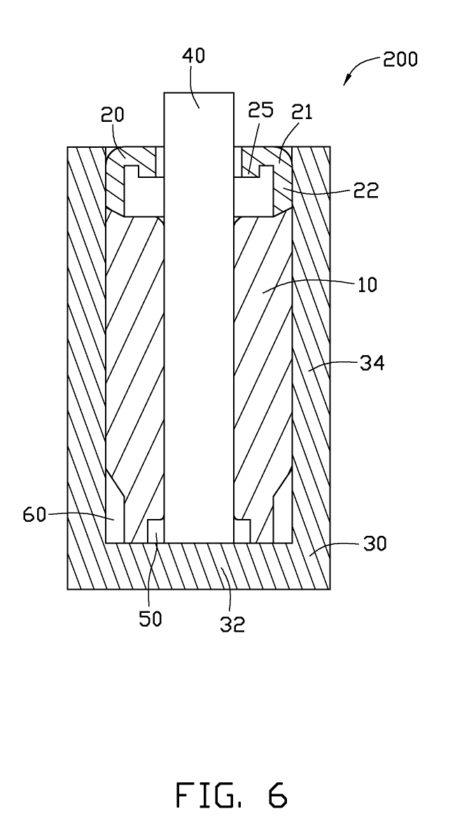

Referring to FIG. 6, a bearing device 200 in accordance with a second embodiment of the disclosure is shown. The bearing device 200 is similar to the bearing device 100 of the first embodiment. The difference of the bearing device 200 from the bearing device 100 of the first embodiment is that the cover 20 includes a guiding portion 25 extending downwards from an inner edge of the central hole 210 of the cover 20. The guiding portion 25 prevents the lubricant from leaking out of the cover 20.

It is to be further understood that even though numerous characteristics and advantages have been set forth in the foregoing description of the embodiment(s), together with details of the structures and functions of the embodiment(s), the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. A bearing device, comprising:
a cylindrical body defining an axial hole for rotatably receiving a rotatable member therein, the body defining a guiding groove at a side wall thereof, the guiding groove having a bottom end communicating a bottom of the axial hole and a top end at the body, the body defining a bore in a middle portion thereof to communicate the axial hole and the top end of the guiding groove, whereby lubricant can flow in a loop in the body.

2. The bearing device of claim 1 further comprising a cover, wherein the cover comprises a top circular wall and an annular wall extending downward from a periphery of the top circular wall.

3. The bearing device of claim 2, wherein the cover defines a central hole and comprises a guiding portion extending downwards from an inner edge of the central hole.

4. The bearing device of claim 2, wherein the body defines a recess at a top thereof and has a planar surface and an inclined surface around the planar surface in the recess of the top.

5. The bearing device of claim 4, wherein a bottom of the body defines a through groove to divide the bottom of the body into two walls, inner surfaces of the walls forming a first storing room communicating the axial hole and the through groove.

6. The bearing device of claim 5, wherein the bottom of the body defines an annular undercut to have a guiding surface, the guiding surface forming a second storing room to communicate the bottom end of the guiding groove to the through hole of the bottom of the body.

7. The bearing device of claim 6, wherein a diameter of the guiding surface gradually decreases from top to bottom.

8. The bearing device of claim 1, wherein the body is made of metal power and formed by an injection molding process.

9. A bearing assembly, comprising:
a bushing comprising a bottom plate and a sleeve extending from a periphery of the bottom plate;
a cylindrical body defining an axial hole, the body defining a guiding groove at a side wall, the guiding groove having a bottom end communicating a bottom of the axial hole and a top end at a middle portion of the body, the body defining a bore communicating an inner of the axial hole and the top end of the guiding groove,
a rotatable member rotatably received in the axial hole of the body; and
lubricant being retained between the rotatable member and the body, part of the lubricant flowing in a loop along the axial hole, the bore and the guiding groove, thereby preventing the lubricant from leaking out of the bearing device.

10. The bearing assembly of claim 9 further comprising a cover, wherein the cover comprises a top circular wall and an annular wall extending downward from a periphery of the top circular wall.

11. The bearing device of claim 10, wherein the cover defines a central hole and comprises a guiding portion extending downwards from an inner edge of the central hole.

12. The bearing device of claim 10, wherein the body defines a recess at a top thereof and has a planar surface and an inclined surface around the planar surface in the recess of the top.

13. The bearing device of claim 12, wherein a bottom of the body defines a through groove to divide the bottom of the body into two walls, inner surfaces of the walls surrounding a first storing room communicating the axial hole and the through groove.

14. The bearing device of claim 13, wherein the bottom of the body defines an annular undercut to have a guiding surface, the guiding surface forming a second storing room communicating the bottom end of the guiding groove with the through hole of the bottom of the body.

15. The bearing device of claim 9, wherein the body is made of metal power and formed by an injection molding process.
